(19) United States
(12) Patent Application Publication
(10) Pub. No.: US 2007/0016363 A1
(43) Pub. Date: Jan. 18, 2007

(54) Interactive map-based user interface for transportation planning

(75) Inventors: Jin Huang, Mountain House, CA (US); Vijay Pillarisetti, Fremont, CA (US); Roy Isaac Peterkofsky, San Francisco, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, Redwood Shores, CA (US)

(21) Appl. No.: 11/182,221

(22) Filed: Jul. 15, 2005

(51) Int. Cl. G01C 21/00

(52) U.S. Cl. 701/201

(57) ABSTRACT

Systems, methodologies, and other embodiments associated with a transportation planning system having an interactive map-based user interface are described. One exemplary computer-implemented method may include accessing a transportation plan having elements like actionable loads and displaying a map of a region related to the transportation plan. The method may also include providing a user interface object for accessing elements of the transportation plan and establishing a dedicated connection between the user interface object and a transportation plan data server. The method may also include displaying an interactive graphical image associated with the user interface object and receiving user inputs concerning a transportation plan element(s) having a dedicated connection to the user interface object. In response to receiving a user input the method may display additional information associated with the transportation plan element, facilitate editing a transportation plan element, facilitate updating and redisplaying the interactive graphical image, and so on.

### BACKGROUND

An entity like a manufacturer that will contract with different carriers and different types of carriers to deliver various items may employ a transportation planning system to attempt to minimize delivery costs. The inputs to a transportation planning system may be, for example, orders that need to be carried. The outputs of the system are an actionable plan for carrying the orders that constituted the input. In some cases, the outputs from a transportation planning system may also include, for example, a map that shows sources from which shipments of orders will depart, paths across which shipments will travel, and destinations at which shipments will arrive. Conventionally this map has been a static map that simply provides a graphical representation of some aspects of an actionable plan of loads produced by the transportation planning system. Thus the outputs from a transportation planning system would also typically include underlying data like lists of truckload shipments, tables of less than truckload shipments, records of package shipments, notations concerning continuous moves, and the like. Conventionally it has been necessary to correlate the static map representation with the underlying data.

An order is the atomic element of a transportation planning system. An order may be described by parameters like a quantity, a request date, an earliest acceptable delivery date, a latest acceptable delivery date, a scheduled ship date, a scheduled arrival date, a promised delivery date, and so on. A transportation planning system facilitates determining how to ship to satisfy the orders. Thus, a transportation plan that includes an actionable plan of loads will satisfy some (hopefully all) of the orders. The actionable plan of loads may include, for example, a set of consolidated shipments along with a specific route, mode (e.g., parcel, less-than-truckload (LTL), truckload (TL)), carrier, service, vehicle selection, and so on for each shipment. This actionable plan of loads may be provided as a table or list oriented textual representation.

Transportation planning systems may employ multi-criteria, constraint-based, decision-making to facilitate, for example, minimizing transportation costs by intelligently processing orders into an actionable plan of loads. Transportation planning systems may also be configured to facilitate improving planning considerations like on-time delivery, customer satisfaction, routing guide compliance, preferred carrier usage, volume-based pricing usage, and so on. Thus, a rich set of data may reside behind the decisions ultimately leading to shipments being assigned. Minimizing transportation costs while improving planning considerations like on-time delivery may produce conflicting and/or competing goals. Therefore transportation planning systems may be configured to selectively make trade-offs between, for example, transportation cost and plan quality to maximize, for example, an overall utility. In this manner, transportation planning systems may violate business rules and/or constraints in order to achieve either additional cost savings or to respect other contradicting rules and/or constraints. When a truckload violates a rule, some annotation may be available on a map that includes a representation of the truckload. For example, a truck route may be colored red to indicate that an exception is associated with the truckload. Typically, a user would then be required to manually sift through underlying data to determine what rule was violated and what, if anything, to do about it. Given that a transportation planning system may handle tens of thousands of orders per day, it is likely that the exception may go unresolved due to planner time constraints. Therefore, the static map representation may lead to unrealized available improvements in transportation planning, which may in turn lead to over spending for shipping or to shipping in a manner that violates business rules or constraints.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example screen shot from a transportation planning system having an interactive map.

FIG. 2 illustrates an example screen shot from a transportation planning system having an interactive map.

FIG. 3 illustrates an example screen shot from a transportation planning system having an interactive map.

FIG. 4 illustrates an example screen shot from a transportation planning system having an interactive map.

FIG. 5 illustrates an example screen shot from a transportation planning system having an interactive map.

FIG. 6 illustrates an example method associated with a transportation planning system having an interactive map.

FIG. 7 illustrates another example method associated with a transportation planning system having an interactive map.

FIG. 8 illustrates an example system associated with a transportation planning system having an interactive map.

FIG. 9 illustrates another example system associated with a transportation planning system having an interactive map.

FIG. 10 illustrates an example computing environment in which example systems and methods illustrated herein can operate.

### DETAILED DESCRIPTION

Example systems, methods, media, and other embodiments described herein relate to a transportation planning system having an interactive map-based user interface. Example systems and methods may facilitate displaying, navigating, and manipulating data associated with a transportation plan. Additionally, example systems and methods may facilitate initiating problem solving or taking corrective actions from live information displayed on a map employed in a location-based application or service like transportation planning. Thus, example systems and methods may facilitate interacting on a more cost effective basis with carriers like parcel carriers (e.g., UPS), less than truckload (LTL) carriers, truckload (TL) carriers and so on. A user may be able to save money by viewing loads and shipments produced by a transportation planning system and then determining how to consolidate smaller shipments (e.g., LTL, parcel) into larger shipments that benefit from economies of scale available in full truckload shipments.

Consider an illustrative daily transportation plan that includes 300 multi-stop truckloads. If 5% of the truckloads are under-utilized, then a planner would be faced with the task of improving the capacity of 15 truckloads. Conventionally, a report may be generated that lists these under-utilized truckloads. On average, identifying LTL, parcel, and unassigned shipments and assessing the impact of adding identified LTL, parcel, and/or unassigned shipments to a trip may take more than one hour per truckload. In the example, this could require over fifteen hours just to resolve this one type of exception. A transportation plan may also include other types of exceptions. Thus, in conventional systems, the time spent in resolving exceptions may exceed the time initially gained by automating transportation planning, or the exceptions may go unresolved. Therefore, example systems and methods provide advancements in how information regarding a transportation plan is presented to a user and thus facilitate user interaction with (e.g., manipulation of) a transportation plan.

Example systems and methods display transportation plan data in a way that facilitates identifying and responding to exceptions. For example, an under-utilized truckload may be illustrated by a red line on a map. The red line may be interactive, user-selectable, and associated with a user interface object. Thus, a user could select the red line for additional processing by, for example, clicking on the red line, hovering a mouse pointer over the red line, and so on. When selected, additional information associated with the under-utilized truckload may be displayed and the user may be able to edit the load, view what-if scenarios based on the edit, accept or reject the edit and/or update the transportation plan based on the edit. To accomplish this, the user interface object may have a dedicated data link from a stateful map component to transportation plan elements on a transportation plan data server and their data. A conventional system may produce stateless HTTP (hyper text transfer protocol) requests for additional information that are transmitted back to an HTTP server using a request-response model. Thus, highly interactive client side operations are not typically implemented. Conversely, example systems and methods may employ user interface objects configured with more intelligence and independence that not only facilitate displaying more information but also allow a user to drill down into the graphical representation and to manipulate the data.

Example systems and methods may also facilitate selecting multiple items from a map to examine how they are related and how they could be related. For example, while selecting an under-utilized truckload may provide a first set of information and opportunities, selecting an under-utilized truckload and several geographically proximate parcel and/or LTL shipments may provide a second larger set of information and opportunities for improving transportation plan utility.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer communication”, as used herein, refers to a communication between two or more computing devices (e.g., computer, personal digital assistant, cellular telephone) and can be, for example, a network transfer, a file transfer, an applet transfer, an email, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on. The communication may be based on protocols including HTTP, Java remote method invocation (RMI), FTP, and so on and combinations thereof.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation like that generated during radio-wave and infra-red data communications, or take the form of one or more groups of signals. Common forms of a computer-readable medium include, but are not limited to, a floppy disk, a hard disk, a magnetic tape, other magnetic medium, a CD-ROM, other optical medium, a RAM (random access memory), a ROM (read only memory), an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein can be produced using programming languages and tools like Java, Pascal, C#, C++, C, CGI, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

Elements illustrated in the flow diagrams denote “processing blocks” that may be implemented in logic. In one example, the processing blocks may represent executable instructions that cause a computer, processor, and/or logic device to respond, to perform an action(s), to change states, and/or to make decisions. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), or other logic device.

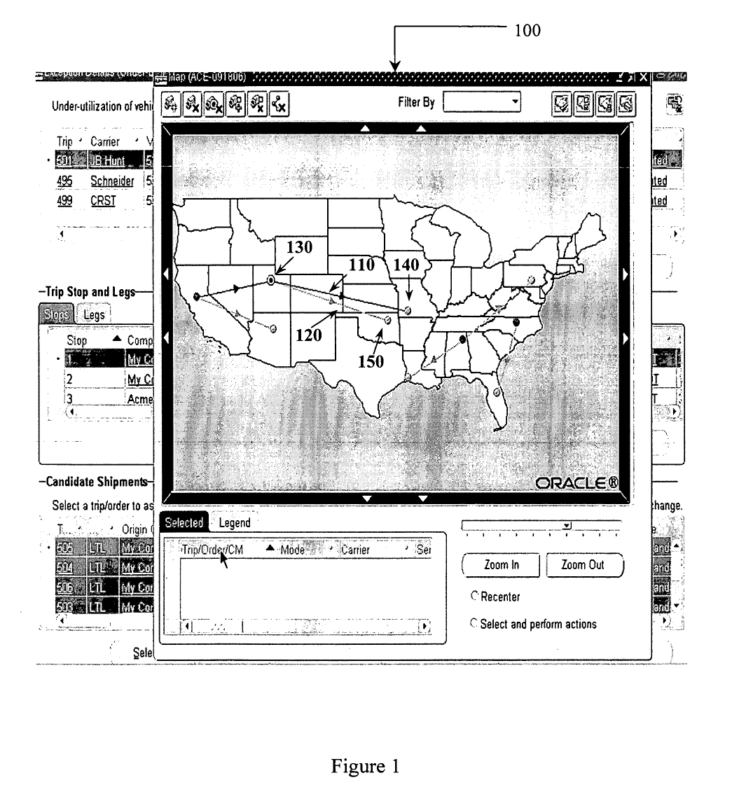

The series of screen shots provided in FIGS. 1 through 5 illustrate an example sequence wherein a map is displayed, a user brings up additional information about a transportation plan element, decides whether to manipulate the transportation plan, and then updates the transportation plan. FIG. 1 illustrates an example screen shot 100 from a transportation planning system having an interactive map. Screen shot 100 illustrates the United States and several transportation plan elements. The elements include sources, destinations, loads that do not violate transportation planning constraints, loads that do violate transportation planning constraints, LTL shipments, parcel shipments, and so on. For example, a truckload is represented by line 110 and an LTL shipment is represented by line 120. Both the truckload 110 and the LTL shipment 120 visit facility 130, which is a stop in a truckload that originated in California. Truckload 110 proceeds to destination 140 while LTL shipment 120 proceeds to destination 150.

At a glance, a user can tell that there is something different about truckload 110 and LTL shipment 120. For example, truckload 110 is illustrated in a dark color while LTL shipment 120 is illustrated in a lighter color. Similarly at a glance a user can tell that there is something different about location 130 and locations 140 and 150 since they are represented as different graphical elements. Location 130 is illustrated as an intermediate stop in a longer truckload while locations 140 and 150 are destinations. As the old saying goes, “a picture is worth a thousand words” and screen shot 100 bears this out.

The screen shot 100 shows that truckload 110 is an “undesirable” transportation plan element because it is under-utilized and thus violates a transportation planning rule. Additionally screen shot 100 illustrates LTL shipment 120 which, although not violating a transportation planning rule, can be identified as an element to hopefully be consolidated and thus eliminated. It is immediately obvious from screen shot 100 which LTL shipments (e.g., 120) are geographically proximate to the truckload 110 and therefore reasonable candidates to be added to the truckload 110. Thus, information represented in the screen shot 100 facilitates identifying shipments that may be reasonably and economically added to truckloads.

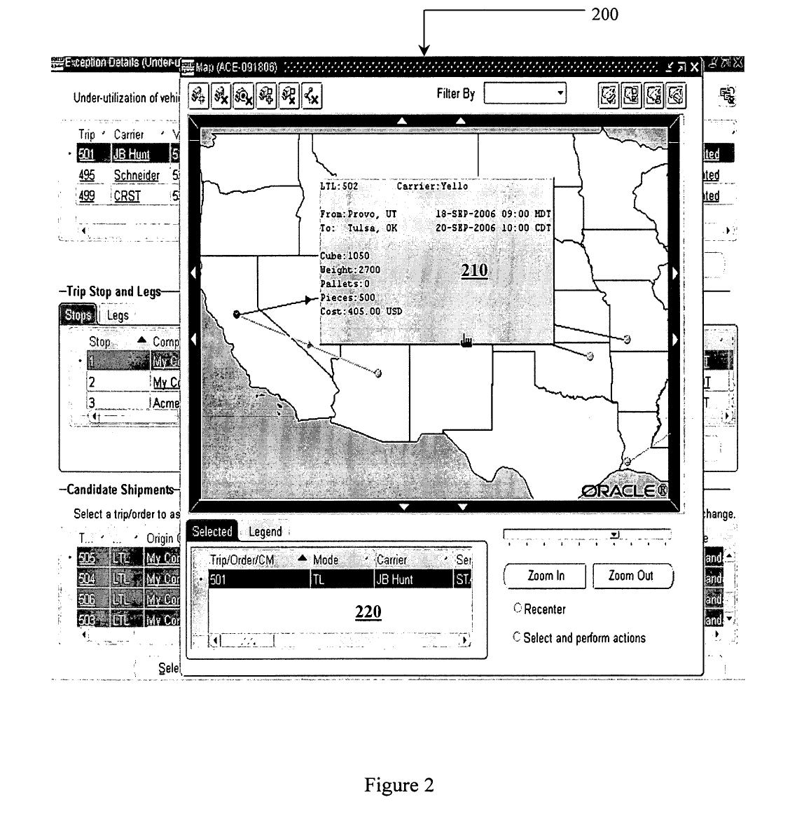

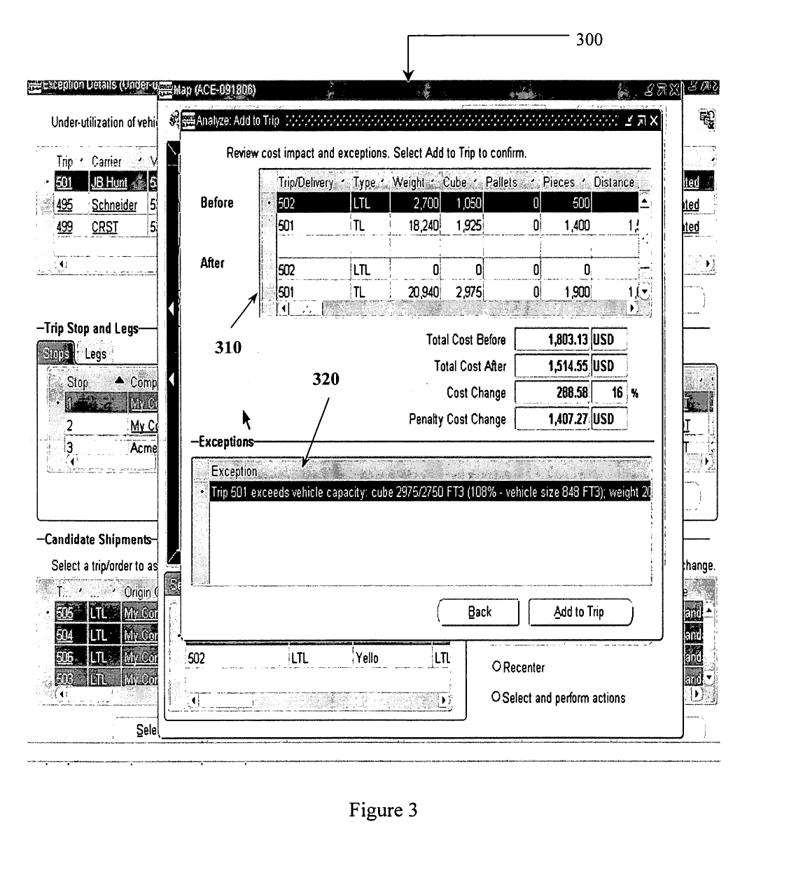

Presented with the graphical data visible in screen shot 100, a user may hover a mouse pointer over truckload 110 to acquire more information about the truckload and its problem(s). Additionally a user may “grab” both truckload 110 and LTL shipment 120 by drawing a box over them or by selecting both of them by individual actions. Thus, FIG. 2 illustrates an example screen shot 200 after the user has hovered the mouse pointer over LTL shipment 120, which is identified in detail display 210 as an LTL shipment with an identification number 502, a source at Provo, Utah and a destination at Tulsa, Okla. Screen shot 200 includes detail display 210, which provides more information about LTL shipment 120. Screen shot 200 also includes a text area 220 that also provides additional information about selected items, in this case truckload 110. Note that the map has been zoomed in and centered over the region of interest. In one example, this can be automated by selecting an item on a map and invoking a custom zoom function. Having become familiar with load 110 and LTL shipment 120, a user may wish to engage in problem solving to improve transportation plan utility. Thus, FIG. 3 illustrates an example screen shot 300 after a user has selected load 110 and LTL shipment 120 for problem solving. Function buttons on the map may facilitate moving from screen to screen and managing the map using the graphical user interface.

Screen shot 300 includes a “before and after” section 310 that shows what would happen if LTL shipment 120 were added to load 110. LTL shipment 120 corresponds to trip 502 and truckload 110 corresponds to trip 501. Attributes like the weight of the shipments, the cubic inches consumed, the number of pieces carried, and so on may be displayed in before and after section 310. Additionally, screen shot 300 includes an exception section 320 that shows the ramifications with respect to business rules and constraints of making the proposed change. In this example, truckload 110 would violate a constraint in that the vehicle would be at 108% of its modeled volume. A planner may know that this type of vehicle can actually carry 110% of the modeled volume and thus may decide to accept the proposed change if, for example, the cost savings justify the associated rule violation(s). Moving LTL shipment 120 onto truckload 110 may add an additional stop to load 110, but may improve overall utility.

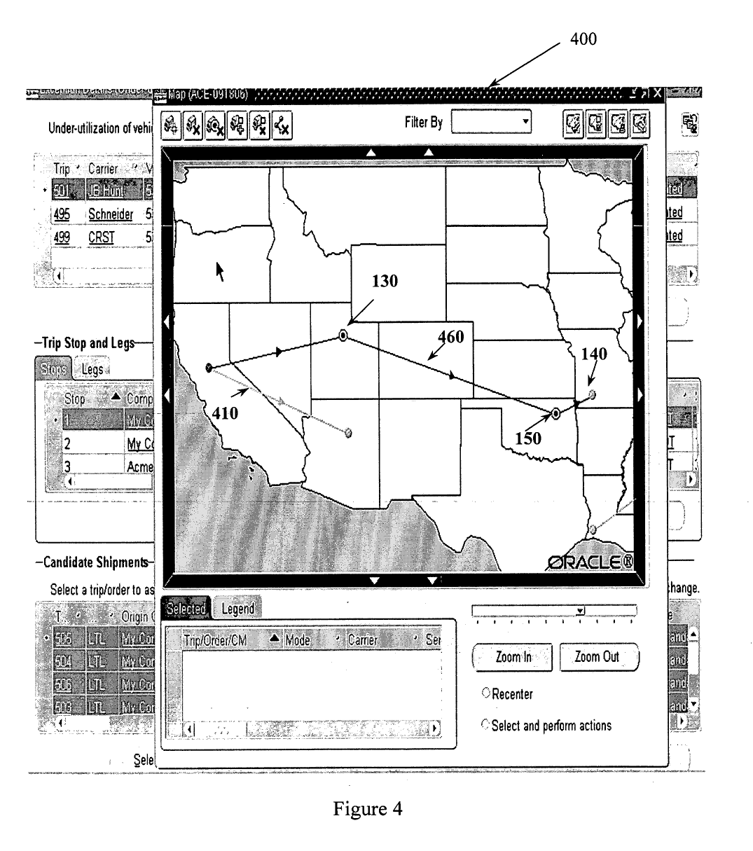

FIG. 4 illustrates an example screen shot 400 taken after the manipulation associated with screen shot 300 has been undertaken. Note that load 460 has been added to the graphical display and that load 110 and LTL shipment 120 have been removed. Further note that load 460 includes stops in both locations 150 and 140. The planner can now tell at a glance that this load has become an “acceptable” load as reflected by a change in color-coding and can transfer attention to other problems.

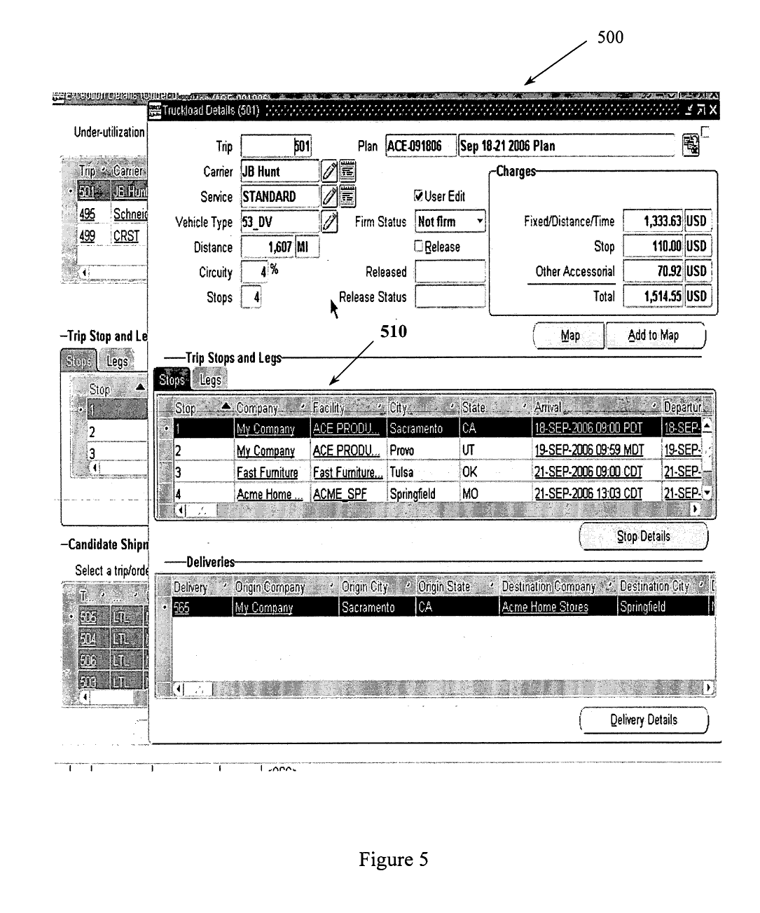

FIG. 5 illustrates an example screen shot 500 from a transportation planning system having an interactive map. Screen shot 500 provides a detail screen concerning a truckload (e.g., trip 501) that includes new load 460. Load 460 can be seen to be part of a longer truckload that originates in Sacramento and ends in Springfield Mo. The data in the “Trips Stops and Legs” section 510 represents live data that reflects the changes made through the highly interactive map as illustrated in FIGS. 1 through 4. Thus, these screen shots illustrate example outputs of example systems and methods described herein.

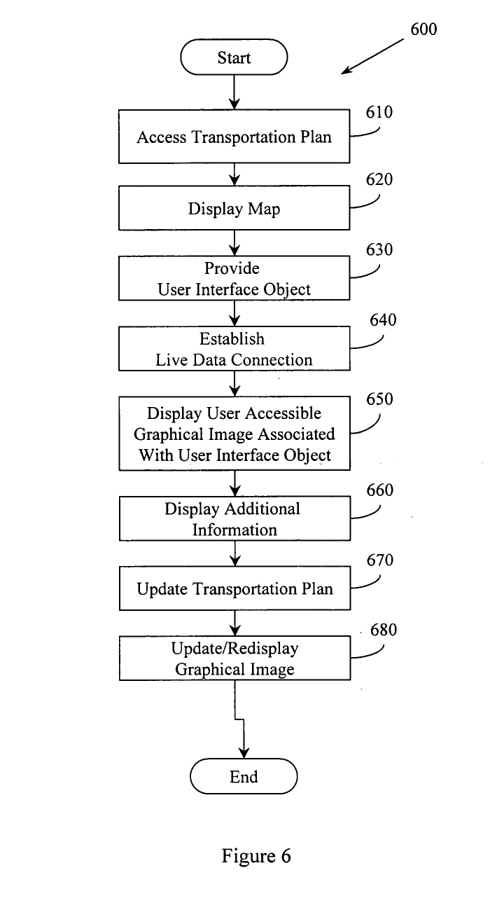

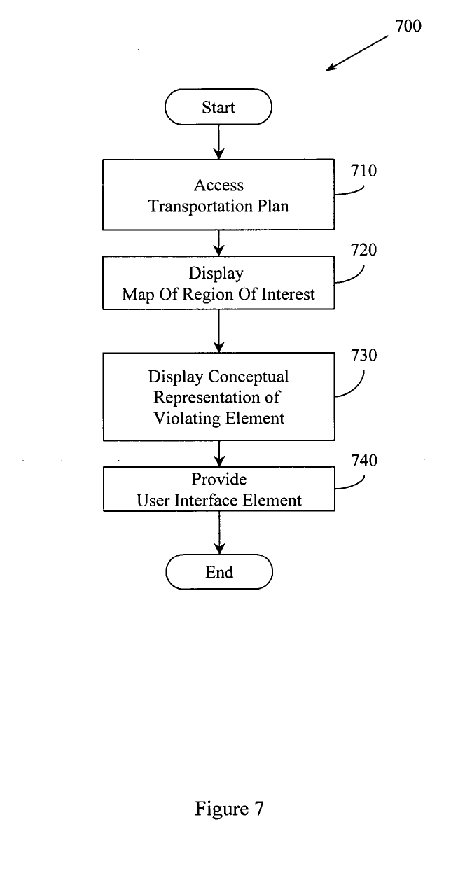

The flow diagrams of FIGS. 6 and 7 are not intended to limit the implementation of the described examples. Rather, the diagrams illustrate functional information one skilled in the art could use to design/fabricate circuits, generate software, or use a combination of hardware and software to perform the illustrated processing.

FIG. 6 illustrates an example computer-implemented method 600 associated with a transportation planning system having an interactive map. Method 600 may include, at 610, accessing a transportation plan. The transportation plan may include data concerning transportation plan elements like orders, shipments, loads, continuous moves, origins, destinations, facilities, and so on. The transportation plan may be produced, for example, by a transportation planning system. Method 600 may, therefore, be configured to facilitate displaying information about the transportation plan, navigating through data in the transportation plan, and selectively updating the transportation plan. In one example, the transportation plan may be provided by a server computer while method 600 executes on a client computer. Accessing the plan may include, for example, locating the plan on a remote computer, establishing a pair of client and server side objects for communicating with the plan, and so on.

Method 600 may also include, at 620, displaying a map of a geographic region associated with the transportation plan. In one example, a map of an entire geographic region (e.g., United States, North America) associated with the transportation plan may be displayed. In another example, a map of a smaller region (e.g., Utah, New England) having transportation plan elements (e.g., truckloads) that violate transportation plan constraints may be displayed. Thus, different maps may be displayed to facilitate identifying and responding to suboptimal conditions in the transportation plan. The map may be dynamically generated by a server object based on the plan output and displayed on a computer screen at a client as an image streamed from the server, for example.

Method 600 may also include, at 630, providing a user interface object that is configured to facilitate accessing a transportation plan element. The user interface object may be, for example, a client side Java component that displays the graph at 620. The client side Java component may implement, for example, a stateful map component. The user interface object facilitates relating a transportation plan element to a visual display and accepting user inputs directed at that transportation plan element. For example, a transportation plan may include a truckload. The truckload may violate a transportation plan constraint. The user interface object may facilitate displaying an image like a dotted red line that indicates that a truckload exists between a source and a destination and also that the truckload violates a transportation plan constraint like under-utilization. “Object”, when used to refer to the user interface object, connotes a combination of data and methods as typically referred to in object oriented programming.

To facilitate displaying, navigating, and manipulating the transportation plan, method 600 may also include, at 640, establishing a remote dedicated connection between a user interface object and a map viewer object on a server that communicates with a spatial map data server and a transportation plan data server. For example, data concerning one or more truckloads may be acquired from the transportation plan and be available for the user interface object to display and to update. In one example, the system can be configured to graphically distinguish between truckloads that violate one or more transportation plan constraints. This dedicated data connection therefore can also provide updated data back to the transportation plan.

With the live data available, method 600 may also include, at 650, displaying on the map an interactive graphical image associated with the user interface object. Being “interactive” means that a user can direct inputs like mouse clicks, drag and drop actions, pointer positioning, and so on at the graphical image and that the user interface object will be able to detect and handle these actions without generating a round-trip communication with the server for every user interaction. Thus, unlike conventional systems in which a static map is displayed, a more interactive map is provided. While a single image is described, it is to be appreciated that a plurality of images may be displayed and that they may be individually and/or collectively interactive.

Since the map is made interactive by displaying the user accessible graphical image(s) at 650, method 600 may also include, at 660, in response to receiving a user input through the user interface object, displaying on the map additional information associated with the transportation plan element. The additional information may facilitate determining whether to initiate a problem-solving task, whether to ignore a violated constraint, whether to examine other related transportation plan elements, and so on. Thus, displaying the additional information associated with the transportation plan element may include displaying a detail report, displaying an exception report, and displaying a potential change report. The additional information may be displayed in response to a user input, user interface, hovering over a graphical image, clicking on a graphical image, drawing a box over a set of graphical images, and so on.

A detail report may include, for example, underlying data like a percent utilization, a source, a destination, a set of orders, a set of shipments, a set of stops, pooling point actions, and the like. Thus, displaying the detail report may facilitate determining whether to leave the transportation plan alone or whether to try to make an edit to the transportation plan. In prior systems, detail report information, if available at all, would be available in a set of printed reports or in a computer file not directly linked to any graphical transportation planning system output. An exception report may include, for example, underlying data like which constraint(s) has been violated, a penalty cost associated with violating the constraint, a history of related constraint violations associated with the carried commodity, the carrier, the geographic region, and so on. Thus, the exception report may facilitate determining whether to try to edit the plan to resolve the violation. Once again, in prior systems, this exception information, if available at all, would be available in a report or printout but not directly associated with any graphical transportation planning output. A potential change report may include, for example, potential changes that may be made to the transportation plan and the changes that would flow from making those changes. For example, a truckload may be under-utilized. The detail report may show what commodity is being carried on the truckload and from where to where. The exception report may show the exception violation (e.g., under-utilized). The potential change report may provide information concerning different shipments that can be moved onto the under-utilized truck to increase its utilization. The potential change report may also provide information about how moving the shipment from one truckload to another truckload may influence other truckloads, overall utility, overall cost, and so on.

Thus, method 600 may also include, at 670, selectively updating the transportation plan based on a user input and, at 680, selectively updating and redisplaying the user accessible graphical image based on whether the transportation plan was updated at 670. Updating the transportation plan can include one action or several actions. For example, updating the transportation plan can include, but is not limited to, assigning an order to a shipment, assigning a shipment to a load, aggregating two or more shipments, deleting a load, creating a continuous move, adding a stop to a load, removing a stop from a load, adding a load, removing a load, adding a destination, adding a pooling point, and adding a drop trailer action by providing updated transportation plan data from the user interface object to the transportation plan, and so on. As described above, a potential change display may be provided that shows different possible updates and their impact(s) on other loads. By way of illustration, a potential change display may propose aggregating two or more shipments that were scheduled for parcel delivery into a single truckload. This may require more than the usual capacity from a truckload carrier. Thus, the carrier may charge over and above their standard contract rate. However, the additional charge may be less than the cost of the two parcel deliveries and thus the savings may be sufficient to warrant exceeding the usual capacity. Therefore, a user may be presented with this option. After evaluating the option, the user may decide whether to accept or reject the option based on factors involved including cost-related and business rule-related factors. If accepted, then the change may be propagated back to the transportation plan.

While FIG. 6 illustrates various actions occurring in serial, it is to be appreciated that various actions illustrated in FIG. 6 could occur substantially in parallel. By way of illustration, a first process could access a transportation plan, a second process could provide user interface objects, and a third process could establish and maintain dedicated links between the user interface objects and the transportation plan data server. A fourth process could display additional information while a fifth process could update the transportation plan based on user responses to the additional information. While five processes are described, it is to be appreciated that a greater and/or lesser number of processes could be employed and that lightweight processes, regular processes, threads, and other approaches could be employed.

In one example, methodologies may be implemented as processor executable instructions and/or operations stored on a computer-readable medium. Thus, in one example, a computer-readable medium may store processor executable instructions operable to perform a method for accessing a transportation plan. The method may include displaying a map of a geographic region associated with the transportation plan, providing a user interface object for accessing transportation plan elements, and establishing a dedicated connection between the user interface object and a transportation plan data server. The method may also include displaying a user accessible graphical image associated with the user interface object and in response to receiving user inputs through the user interface object, displaying additional information associated with the transportation plan element, selectively updating the transportation plan, and selectively updating and redisplaying the user accessible graphical image. While the above method is described being stored on a computer-readable medium, it is to be appreciated that other example methods described herein can also be stored on a computer-readable medium.

FIG. 7 illustrates an example method 700 associated with a transportation planning system having an interactive map. Method 700 may include, at 710, accessing a transportation plan. The transportation plan may include, for example, data concerning a plurality of truckloads. In some cases a truckload may violate a transportation planning constraint like utilization, delivery time, driver time, and the like.

Thus, method 700 may also include, at 720, displaying a map of a geographical region having a truckload that violates a transportation planning constraint. While a transportation planning system may have an interactive map capable of showing all loads, in some cases a planner may only be interested in “problem loads” like those that violate planning constraints. Thus, being able to generate a specialized map focused on a region where a problem load exists facilitates a planner removing inefficiencies from a transportation plan.

To further facilitate improving a transportation plan by removing inefficiencies, method 700 may also include, at 730, displaying a conceptual representation of a truckload that violates the transportation planning constraint. For example, under-utilized truckloads may appear as red lines connecting a source and a destination via a set of stops, over-utilized truckloads may appear as yellow lines connecting a source and a destination via a set of stops, facilities whose docking capacity are over utilized may appear as flashing red circles, facilities scheduled to receive shipments for which they are not equipped (e.g., secure materials in an insecure location) may appear as rotating blue triangles, and so on. Thus, the planner can identify problems by looking at the interactive map.

Having identified where a problem exists, the planner may be further aided by method 700, when, at 740, it provides a user interface element that facilitates examining the truckload, the facility, and so on and transportation planning constraints being compromised by that entity. The user interface element may also facilitate manipulating data concerning the truckload, facility, and so on and therefore facilitates resolving the violation of a transportation planning constraint.

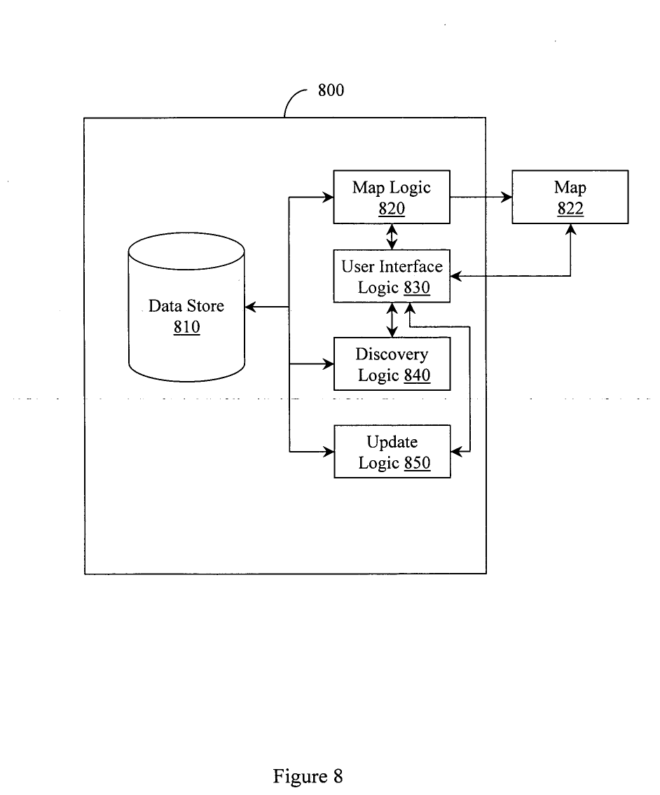

FIG. 8 illustrates an example system 800 that is configured to manipulate a transportation plan. System 800 may include a data store 810 that is configured to store data concerning items like a transportation planning model, a transportation plan, a set of orders, and geographical geometry data concerning locations and facilities referred to in other data items. A transportation planning model may include, for example, data concerning routes, carriers, vehicles, constraints, preferences, rules, rates, facilities, a transportation network over which the vehicles will travel, and so on. A route may describe, for example, a set of roads to be traversed by a vehicle. A carrier may describe, for example, a trucking company that provides the vehicle and driver(s) for a load. A constraint may describe, for example, commodities that are not allowed to travel together, commodities that must be carried by certain types of vehicles, commodities that may not traverse certain roads, and so on. A preference may describe, for example, a relationship between a preferred carrier and a commodity, a relationship between a preferred carrier and a route, a relationship between a preferred carrier and a region, a relationship between sets of orders, and so on. A rule may describe, for example, a maximum weight for a vehicle, a maximum number of hours per day of service for a driver, a maximum volume for a vehicle, and so on. A rate may describe, for example, how much is charged to carry a certain amount of a commodity by a certain mode (e.g., package, LTL, TL) in a certain period of time. A facility may describe, for example, the facility location, the facility operation hours, the facility capacity, and so on. The transportation network data may describe, for example, paths vehicles can traverse, transit times over those paths, costs associated with traversing the path, commodity restrictions for a path, and so on. While example constraints, preferences, rules, rates, and so on are described, it is to be appreciated that other examples may be possible.

A transportation planning system may have configurable optimization parameters like target truckload utilization percentages, minimum truckload utilization percentages, maximum deadhead distance requirements, and so on. Thus, information concerning these parameters may be stored, for example, in the transportation planning model stored in data store 810. Similarly, a transportation planning system may be configurable with respect to how decisions are made concerning, for example, consolidation, routing, carrier selection, and so on. Data concerning how these decisions are to be made may also be stored in data store 810. The decision-making may be made in light of constraints that may also be stored, for example, in the transportation planning model in data store 810. The constraints may concern, for example, carrier load rules like a maximum number of stops, a maximum total distance, a maximum total time, a maximum total distance in twenty four hours, a minimum layover time, a maximum driving time in twenty four hours, a maximum on-duty time in twenty four hours, and so on. The constraints may also concern, for example, compatibilities between customers, facilities, suppliers, modes, carriers, vehicles, items, and so on. The constraints may also concern, for example, timing issues like late delivery, early delivery, late pick-up, early pick-up, facility operating hours, and so on. The constraints may also concern, for example, carrier commitments like load, weight, spending limits, and so on. While several types of constraints have been described, it is to be appreciated that other types of constraints may be employed. It will be appreciated that while some business rules and/or constraints are binary in nature (e.g., either violated or not violated), it may be desirable to selectively violate a rule and/or constraint to save money, to avoid violating other rules and/or constraints, and so on. A human planner may have an intuitive grasp of the tradeoffs involved when violating a rule and/or constraint and may select the best choice when rule violations and cost impacts are enumerated, which may be facilitated by interactive map-based user interfaces provided by example systems and methods described herein.

System 800 may also include a map logic 820 that is operably connected to data store 810. Map logic 820 may be configured to display a map 822 that is related to the transportation plan. For example, the map 822 may show a region (e.g., country, state) in which commodities will be moved by carriers as described by the transportation plan. In one example, the map logic 820 may be configured to access data store 810 and to determine a geographic region to display on the map 822 based on an exception associated with an actionable load in the transportation plan. Providing a “problem map” like this may facilitate focusing planner attention on perceived problems and solutions and thus may facilitate resolving problems. This mitigates issues associated with information overload that might occur if the planner is presented with information concerning all orders, shipments, loads and so on instead of just those that violate constraints, particularly when the information is presented in bulk text form rather than graphical form. Of course, the map logic 820 can be configured to access data and display a map 822 relating to different selected truckloads.

System 800 may also include a user interface logic 830 that is operably connected to the map logic 820. User interface logic 830 may be configured to overlay on the map 822 an interactive graphical representation of a transportation plan element. Having displayed the graphical representation of the element, user interface logic 830 may then accept user inputs (e.g., keystrokes, mouse clicks, light pen touches) concerning the interactive graphical representation. Based on the input (e.g., left click, right click), the user interface logic 830 may display on the map additional information concerning the transportation plan element. While a single interactive graphical representation of a transportation plan element is described, it is to be appreciated that user interface logic 830 may be distributed between the client and server components and may display a plurality of independent and/or related interactive graphical representations.

In this example, map logic 820 may be a client side Java object that communicates with a remote server and/or remote server objects. The map logic 820 may facilitate providing a stateful map component on the client side. Displaying additional information concerning the transportation plan element may include, for example, selectively displaying a detail report, selectively displaying an exception report, and selectively displaying a hypothetical report. In one example, the user interface logic 830 may be configured to display the hypothetical report without updating the transportation plan.

System 800 may also include a discovery logic 840 that is operably connected to the user interface logic 830 and the data store 810. The discovery logic 840 may be configured to locate additional information associated with a transportation plan element associated with a graphical representation displayed by user interface logic 830. In one example, the data may be stored in data store 810. Since the transportation plan may be a dynamic plan, the discovery logic 840 may be configured to maintain a live data link with the data store 810. Thus, while a first planner is working on a first problem with the transportation plan and a second planner is working on a second problem with the transportation plan they may both be presented with live data corresponding to the actual state of affairs in the transportation plan rather than with a static display of information available before corrective actions began.

System 800 may also include an update logic 850 that is operably connected to the user interface logic 830 and the data store 810. The update logic 850 may be configured to facilitate manipulating the transportation plan. Whether and how the transportation plan is manipulated may be determined, for example, by a user input. The update logic 850 may be configured to manipulate the transportation plan in different ways. For example, the update logic 850 may be configured to facilitate actions including, but not limited to, assigning an order to a shipment, assigning a shipment to a load, aggregating two or more shipments, deleting a load, creating a continuous move, adding a stop to a load, adding a load, removing a load, adding a destination, adding a pooling point, and adding a drop trailer action.

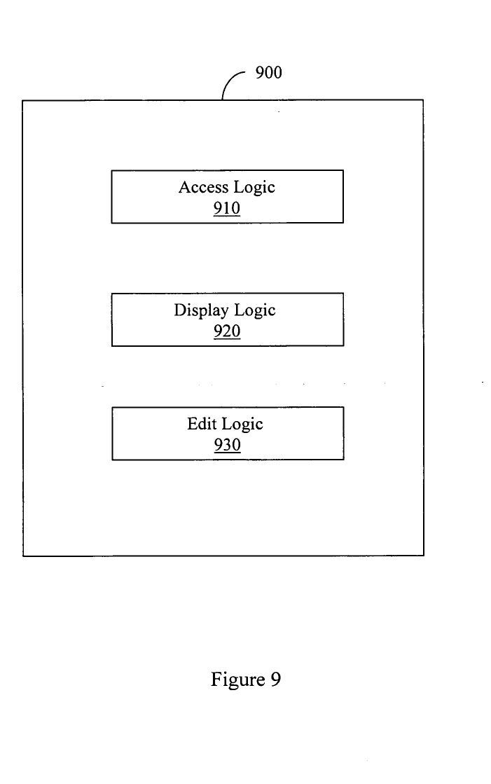

FIG. 9 illustrates an example system 900 associated with a transportation planning system having an interactive map. System 900 may include an access logic 910 implemented in hardware, software, firmware and/or a combination thereof that facilitates accessing a transportation plan having actionable elements like actionable truckloads. System 900 may also include a display logic 920 that is implemented in hardware, software, firmware, and/or a combination thereof that facilitates displaying on a computer (e.g., personal computer, PDA, cellular telephone, Blackberry) a map of a region associated with actionable truckloads. Display logic 920 may also facilitate graphically displaying actionable elements of the transportation plan and graphically navigating through actionable elements of the transportation plan. System 900 may also include an edit logic 930 implemented in hardware, software, firmware, and/or a combination thereof that facilitates updating actionable elements of the transportation plan.

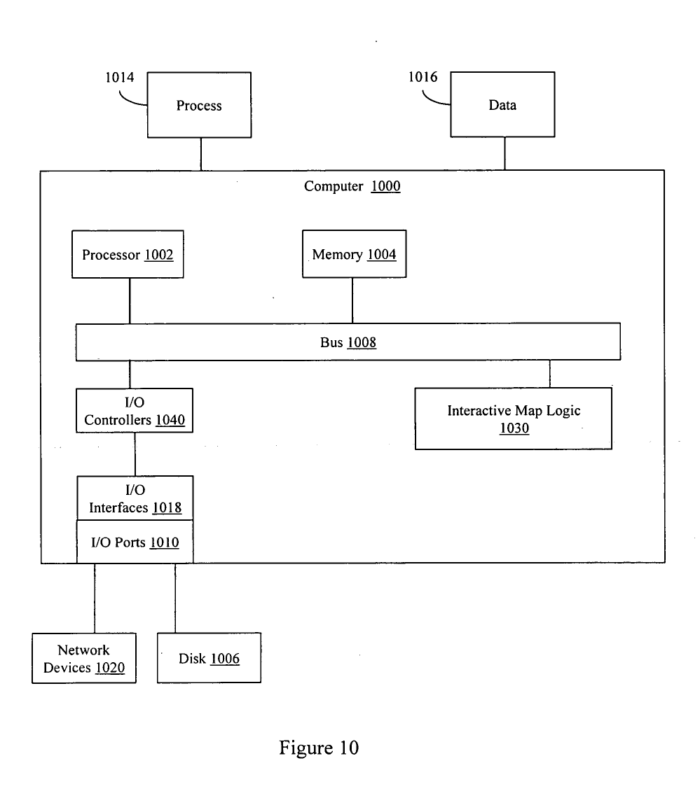

FIG. 10 illustrates an example computing device in which example systems and methods described herein, and equivalents, can operate. The example computing device may be a computer 1000 that includes a processor 1002, a memory 1004, and input/output controllers 1040 operably connected by a bus 1008. In one example, the computer 1000 may include an interactive map logic 1030 that is configured to facilitate providing an interactive map for a transportation planning system. Interactive map logic 1030 may implement portions of example systems described herein and may execute portions of example methods described herein. Thus, whether implemented in hardware, software, firmware, and/or combinations thereof, interactive map logic 1030 and computer 1000 may provide means (e.g., hardware, software, firmware) for accessing a transportation plan, means (e.g., hardware, software, firmware) for displaying a map of a region associated with the transportation plan, means (e.g., hardware, software, firmware) for graphically displaying actionable elements of the transportation plan, means (e.g., hardware, software, firmware) for graphically navigating through actionable elements of the transportation plan, and means (e.g., hardware, software, firmware) for updating actionable elements of the transportation plan. While interactive map logic 1030 is illustrated as a hardware component attached to bus 1008, it is to be appreciated that in one example, interactive map logic 1030 could be implemented in software, stored on disk 1006, brought into memory 1004, and executed by processor 1002.

Generally describing an example configuration of computer 1000, processor 1002 can be a variety of various processors including dual microprocessor and other multi-processor architectures. Memory 1004 can include volatile memory and/or non-volatile memory. Disk 1006 may be operably connected to computer 1000 via, for example, an input/output interface (e.g., card, device) 1018 and an input/output port 1010. Disk 1006 can include, but is not limited to, devices like a magnetic disk drive, a solid state disk drive, a floppy disk drive, a tape drive, a Zip drive, a flash memory card, and/or a memory stick. Furthermore, disk 1006 can include optical drives like a CD-ROM, a CD recordable drive (CD-R drive), a CD rewriteable drive (CD-RW drive), and/or a digital video ROM drive (DVD ROM). The memory 1004 can store processes 1014 and/or data 1016, for example. Disk 1006 and/or memory 1004 can store an operating system that controls and allocates resources of computer 1000.

Bus 1008 can be a single internal bus interconnect architecture and/or other bus or mesh architectures. While a single bus is illustrated, it is to be appreciated that computer 1000 may communicate with various devices, logics, and peripherals using other busses that are not illustrated (e.g., PCIE, SATA, Infiniband, 1394, USB, Ethernet).

Computer 1000 may interact with input/output devices via i/o interfaces 1018 and input/output ports 1010. Input/output devices can include, but are not limited to, a keyboard, a microphone, a pointing and selection device, cameras, video cards, displays, disk 1006, network devices 1020, and the like. Input/output ports 1010 can include but are not limited to, serial ports, parallel ports, and USB ports.

Computer 1000 can operate in a network environment and thus may be connected to network devices 1020 via i/o devices 1018, and/or i/o ports 1010. Through network devices 1020, computer 1000 may interact with a network. Through the network, computer 1000 may be logically connected to remote computers. The networks with which computer 1000 may interact include, but are not limited to, a local area network (LAN), a wide area network (WAN), and other networks. Network devices 1020 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, network devices 1020 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-implemented method, comprising:
accessing a transportation plan comprising transportation plan elements, the transportation plan being located on a transportation plan data server;
displaying a map of a geographic region associated with the transportation plan;
providing a user interface object configured to facilitate accessing a transportation plan element;
establishing a dedicated connection between the user interface object and the transportation plan data server;
displaying on the map an interactive graphical image associated with the user interface object; and
in response to receiving a user input through the user interface object:
displaying on the map additional information associated with the transportation plan element;
selectively updating the transportation plan based, at least in part, on the user input; and
selectively updating and redisplaying the interactive graphical image based, at least in part, on whether the transportation plan was updated.

2. The method of claim 1, a transportation plan element being one of, an order, a shipment, a load, a continuous move, an origin, a destination, and a facility.

3. The method of claim 1, the user interface object being configured to recognize user interactions without relying on HTTP requests to the transportation plan data server, to access the transportation plan element, and to display on the map additional information associated with the transportation plan.

4. The method of claim 3, the user interface object being a client side Java object configured to render dynamically generated images onto the map and to handle user inputs.

5. The method of claim 1, where establishing the dedicated data connection includes acquiring data from the transportation plan and providing updated data to the transportation plan.

6. The method of claim 1, the transportation plan being stored on a server computer, the method being performed on a client computer, the map being generated by a server object based on the plan output and displayed on a computer screen at the client as an image streamed from the server.

7. The method of claim 1, where displaying on the map additional information associated with the transportation plan element comprises:
selectively displaying a detail report;
selectively displaying an exception report; and
selectively displaying a potential change report.

8. The method of claim 1, where updating the transportation plan comprises performing one or more of, assigning an order to a shipment, assigning a shipment to a load, aggregating two or more shipments, deleting a load, creating a continuous move, adding a stop to a load, removing a stop from a load, adding a load, removing a load, adding a destination, adding a pooling point, and adding a drop trailer action by providing updated transportation plan data from the user interface object to the transportation plan.

9. A computer-implemented method, comprising:
accessing a transportation plan comprising transportation plan elements, a transportation plan element being one of, an order, a shipment, a load, a continuous move, an origin, a destination, and a facility, the transportation plan being located on a transportation plan data server;
displaying a map of a geographic region associated with the transportation plan;
providing a client side Java object configured to render dynamically generated images onto the map, to handle user inputs, and to facilitate accessing a transportation plan element;
establishing a dedicated connection between the client side Java object and the transportation plan data server by acquiring data from the transportation plan and providing updated data to the transportation plan, the client side Java object being configured to recognize user interactions without relying on HTTP requests to the transportation plan data server, to access the transportation plan element, and to display additional information associated with the transportation plan element;
displaying on the map an interactive graphical image associated with the client side Java object; and
in response to receiving a user input through the client side Java object:
selectively displaying a detail report associated with the transportation plan element;
selectively displaying an exception report associated with the transportation plan element;
selectively displaying a potential change report associated with the transportation plan element;
selectively updating the transportation plan based, at least in part, on the user input, where updating the transportation plan comprises performing one or more of, assigning an order to a shipment, assigning a shipment to a load, aggregating two or more shipments, deleting a load, creating a continuous move, adding a stop to a load, removing a stop from a load, adding a load, removing a load, adding a destination, adding a pooling point, and adding a drop trailer action by providing updated transportation plan data from the Java graph object to the transportation plan; and
selectively updating and redisplaying the interactive graphical image based, at least in part, on whether the transportation plan was updated.

10. A computer-readable medium for providing computer executable instructions operable to perform a method, the method comprising:
accessing a transportation plan comprising transportation plan elements, the transportation plan being located on a transportation plan data server;
displaying a map of a geographic region associated with the transportation plan;
providing a user interface object configured to facilitate accessing a transportation plan element;
establishing a dedicated connection between the user interface object and the transportation plan;
displaying on the map an interactive graphical image associated with the user interface object; and
in response to receiving a user input through the user interface object:
displaying on the map additional information associated with the transportation plan element;
selectively updating the transportation plan based, at least in part, on the user input; and
selectively updating and redisplaying the interactive graphical image based, at least in part, on whether the transportation plan was updated.

11. A method, comprising:
accessing a transportation plan that comprises data concerning a plurality of truckloads, where a truckload may violate a transportation planning constraint;
displaying a map of a geographical region having a truckload that violates a transportation planning constraint;
displaying on the map a conceptual representation of the truckload that violates the transportation planning constraint; and
providing a user interface element that facilitates examining the truckload and the transportation planning constraint, that facilitates manipulating data concerning the truckload, and that facilitates resolving a violation of a transportation planning constraint.

12. A computer-based system, comprising:
a data store configured to store data comprising a transportation planning model, a transportation plan, and a set of orders, the transportation plan comprising a set of transportation plan elements including actionable loads;
a map logic operably connected to the data store, the map logic being configured to display a map related to the transportation plan;
a user interface logic operably connected to the map logic, the user interface logic being configured to overlay on the map an interactive graphical representation of a transportation plan element, to accept a user input directed at the interactive graphical representation, and to display on the map additional information concerning the transportation plan element based, at least in part, on the user input;
a discovery logic operably connected to the user interface logic and the data store, the discovery logic being configured to locate additional information associated with the transportation plan element, the additional information being stored in the data store; and
an update logic operably connected to the user interface logic and the data store, the update logic being configured to facilitate manipulating the transportation plan based, at least in part, on the user input.

13. The system of claim 12, the map logic being configured to access the data store and to determine a geographic region to display on the map based, at least in part, on an exception associated with an actionable load in the transportation plan.

14. The system of claim 13, the user interface logic being configured to display a conceptual visual representation of an exception on the map.

15. The system of claim 14, the user interface logic being a client side Java object, the transportation plan being provided by a server based transportation planning system.

16. The system of claim 15, where displaying additional information concerning the transportation plan element comprises:
selectively displaying a detail report based, at least in part, on the user input; selectively displaying an exception report based, at least in part, on the user input;
and
selectively displaying a hypothetical report, based, at least in part, on the user input.

17. The system of claim 16, the user interface logic being configured to display the hypothetical report without updating the transportation plan.

18. The system of claim 17, the discovery logic being configured to maintain a live data link with the data store.

19. The system of claim 18, the update logic being configured to manipulate the transportation plan by performing one or more of, assigning an order to a shipment, assigning a shipment to a load, aggregating two or more shipments, deleting a load, creating a continuous move, adding a stop to a load, adding a load, removing a load, adding a destination, adding a pooling point, and adding a drop trailer action.

20. A computer based system, comprising:
means for accessing a transportation plan comprising actionable elements including actionable truckloads;
means for displaying a map of a region associated with the actionable truckloads;
means for graphically displaying actionable elements of the transportation plan;
means for graphically navigating through actionable elements of the transportation plan; and
means for updating actionable elements of the transportation plan.
